(19) United States
(12) Patent Application Publication
(10) Pub. No.: US 2021/0129242 A1
(43) Pub. Date: May 6, 2021

(54) PORTABLE BAND SAW

(71) Applicant: MAKITA CORPORATION, Anjo-shi (JP)

(72) Inventor: Kenta NIWA, Anjo-shi (JP)

(73) Assignee: MAKITA CORPORATION, Anjo-shi (JP)

(21) Appl. No.: 17/078,497

(22) Filed: Oct. 23, 2020

(30) Foreign Application Priority Data
Nov. 5, 2019 (JP) 2019-200909

(51) Int. Cl. B23D 53/12; B23D 55/06; B23D 55/08

(52) U.S. Cl. CPC B23D 53/12; B23D 55/082; B23D 55/06

(57) ABSTRACT

A portable band saw has a substantially equally balanced weight in the lateral direction. The portable band saw includes a battery mount to which a battery is attachable, a motor driven with electric power from the battery, a band saw blade being endless and rotatable with power generated by the motor, a body supporting the motor and the band saw blade, and a handle including a support connected to the body and extending in a vertical direction, and a grip connected to the support and extending in a front-rear direction. The motor has a center on one side of a center of the handle, and the battery has a center on another side of the center of the handle in a lateral direction.

### CROSS-REFERENCE TO RELATED APPLICATIONS

This application claims the benefit of priority to Japanese Patent Application No. 2019-200909, filed on Nov. 5, 2019, the entire contents of which are hereby incorporated by reference.

### BACKGROUND

### 1. Technical Field

The present disclosure relates to a portable band saw.

### 2. Description of the Background

A band saw cutting machine described in, for example, Japanese Unexamined Patent Application Publication No. 2016-147339, and a hand-held band saw described in, for example, U.S. Pat. No. 7,287,454 are known in the field of portable band saws.

### BRIEF SUMMARY

A portable band saw may have a substantially equally balanced weight in the lateral direction to improve operability.

One or more aspects of the present disclosure are directed to a portable band saw with a substantially equally balanced weight in the lateral direction.

An aspect of the present disclosure provides a portable band saw, including:

a battery mount to which a battery is attachable;

a motor driven with electric power from the battery;

a band saw blade being endless and rotatable with power generated by the motor;

a body supporting the motor and the band saw blade; and

a handle including
a support connected to the body and extending in a vertical direction, and
a grip connected to the support and extending in a front-rear direction, wherein in a lateral direction, the motor has a center on one side of a center of the handle, and the battery has a center on another side of the center of the handle.

The portable band saw according to the above aspect of the present disclosure can have a substantially equally balanced weight in the lateral direction.

### BRIEF DESCRIPTION OF DRAWINGS

FIG. 1 is a perspective view of a portable band saw according to an embodiment.

FIG. 2 is a view of the portable band saw according to the embodiment from M-direction.

FIG. 3 is a view of the portable band saw according to the embodiment from L-direction.

FIG. 4 is a view of the portable band saw according to the embodiment from the front.

FIG. 5 is a view of the portable band saw according to the embodiment from S-direction.

FIG. 6 is a view of the portable band saw according to the embodiment from S-direction.

FIG. 7 is a cross-sectional view of the portable band saw according to the embodiment from L-direction.

FIG. 8 is a view of the portable band saw according to the embodiment from above.

FIG. 9 is a view of the portable band saw according to the embodiment from above.

### DETAILED DESCRIPTION

Although one or more embodiments of the present disclosure will now be described with reference to the drawings, the present disclosure is not limited to the embodiments. The components in the embodiments described below may be combined as appropriate. One or more components may be eliminated.

### Portable Band Saw

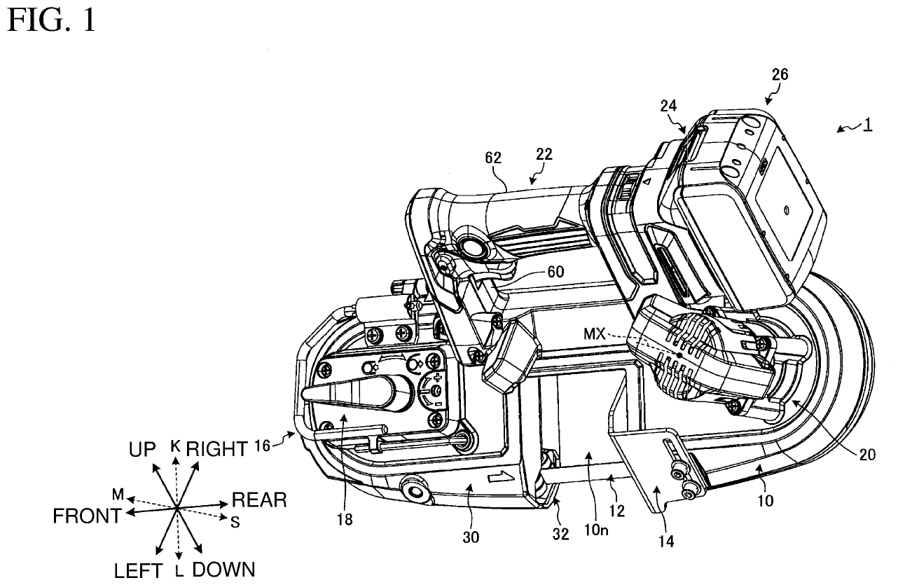

FIG. 1 is a perspective view of a portable band saw 1 according to an embodiment.

As shown in FIG. 1, the portable band saw 1 includes a battery mount 24, a motor 20, a band saw blade 12, a body 10, and a handle 22. The battery mount 24 receives a battery 26. The motor 20 is driven with electric power from the battery 26. The band saw blade 12 is endless, and rotates with power generated by the motor 20. The body 10 supports the motor 20 and the band saw blade 12. The handle 22 is connected to the body 10. The handle 22 includes supports 60 and a grip 62. The supports 60 are connected to the body 10. The grip 62 is connected to the supports 60.

The portable band saw 1 also includes a stopper plate assembly 14, a hook 16, and a tension adjuster 18. The stopper plate assembly 14 supports a workpiece. The hook 16 can be hooked on an object. The tension adjuster 18 adjusts the tension of the band saw blade 12.

In the embodiment, the positional relationships between the components will be described using the directional terms such as right and left (or lateral), front and rear (or forward and backward), and up and down (or vertical). The terms indicate relative positions or directions with respect to the center of the portable band saw 1.

The supports 60 extend in the vertical direction. The grip 62 extends in the front-rear direction. The longitudinal direction of the supports 60 is referred to as the vertical direction. The longitudinal direction of the grip 62 is referred to as the front-rear direction. The direction orthogonal to the vertical direction and the front-rear direction is referred to as the lateral direction.

In the embodiment, the supports 60 protrude upward from the body 10. The battery mount 24 is located rearward from the handle 22. The band saw blade 12 is located leftward from the handle 22.

The direction parallel to a rotation axis MX of the motor 20 is referred to as the M-S direction. The direction orthogonal to the M-S direction and the front-rear direction is referred to as the K-L direction. The vertical direction is oblique to the M-S and K-L directions. In the embodiment, the motor 20 protrudes from the body 10 in M-direction. The band saw blade 12 is located in L-direction from the handle 22.

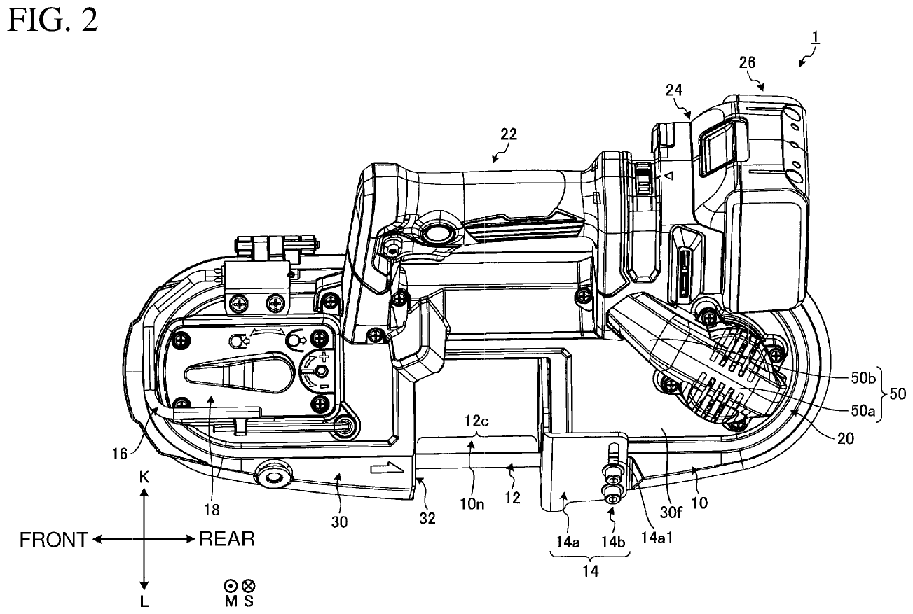

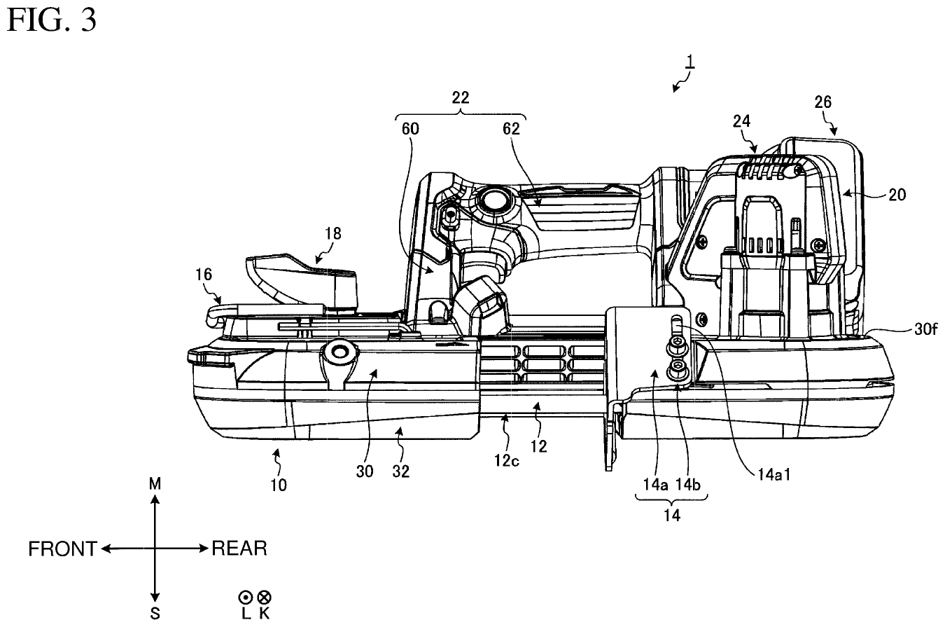

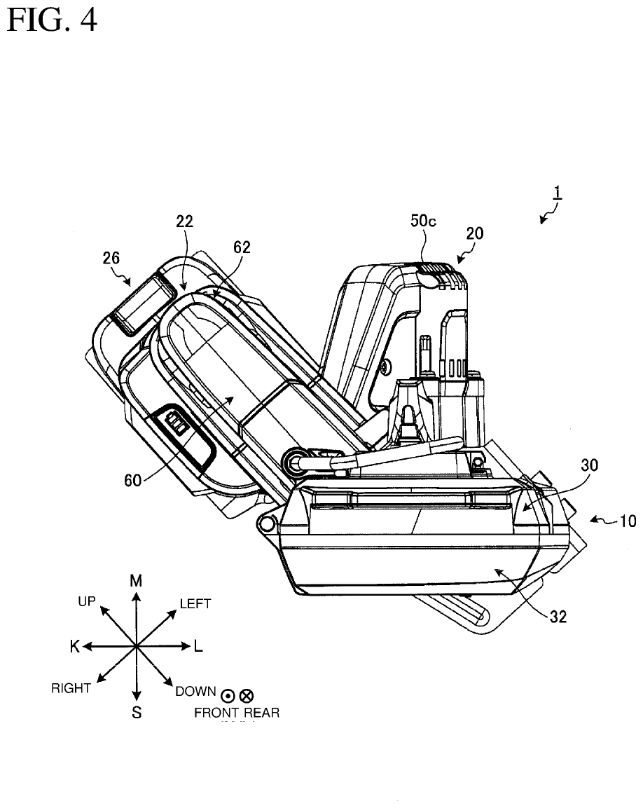

FIG. 2 is a view of the portable band saw 1 according to the embodiment from M-direction. FIG. 3 is a view of the portable band saw 1 according to the embodiment from L-direction. FIG. 4 is a view of the portable band saw 1 according to the embodiment from the front.

As shown in FIGS. 2 to 4, the body 10 is elongated in the front-rear direction. The body 10 has an oval or elliptical profile. The body 10 includes a frame 30 and a cover 32. The frame 30 is located farther in M-direction than the cover 32. The frame 30 is formed from a light metal such as aluminum or magnesium. The frame 30 in the embodiment is formed from aluminum by die casting. The frame 30 has a surface 30f orthogonal to the M-S direction.

The cover 32 covers the frame 30. The cover 32 is located farther in S-direction than the frame 30. The cover 32 is attached to the frame 30 with a hinge. The cover 32 is operable to be open and closed with respect to the frame 30. The cover 32 is formed from a synthetic resin such as polycarbonate or nylon.

The body 10 has an internal space defined between the frame 30 and the cover 32. The band saw blade 12 is at least partially located in the internal space of the body 10. The frame 30 rotatably supports the band saw blade 12.

The frame 30 supports the motor 20. The motor 20 is located on the surface 30f of the frame 30. The handle 22 is connected to the surface 30f of the frame 30. The hook 16 and the tension adjuster 18 are located on the frame 30.

The body 10 has a recess 10n in the center of the body 10 in the front-rear direction. The recess 10n is formed at an end of the body 10 in L-direction along the K-L direction.

The band saw blade 12 is at least partially located in the recess 10n. In the recess 10n, the band saw blade 12 is located in an external space of the body 10.

A cutting target for the portable band saw 1 is at least partially placed in the recess 10n. The band saw blade 12 cuts the workpiece in the recess 10n. The band saw blade 12 located in the recess 10n cuts the workpiece. A part of the band saw blade 12 located in the recess 10n may be hereafter referred to as a cutting portion 12c.

The cutting portion 12c of the band saw blade 12 cuts the workpiece. The cutting portion 12c is located in the external space of the body 10.

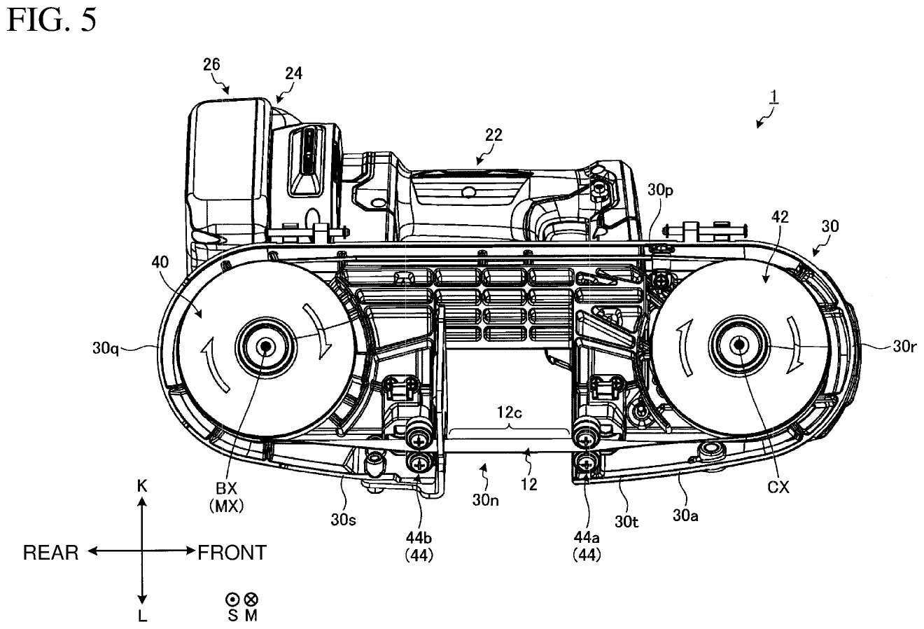

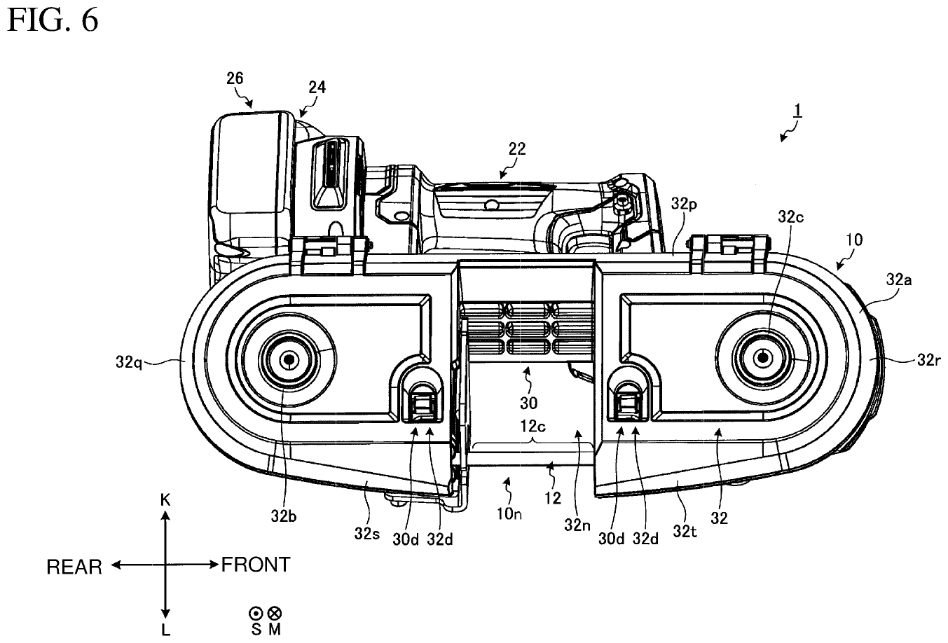

FIG. 5 is a view of the portable band saw 1 according to the embodiment from S-direction. FIG. 5 is a view of the portable band saw 1 with the cover 32 detached from the frame 30. FIG. 6 is a view of the portable band saw 1 according to the embodiment from S-direction.

As shown in FIG. 5, the frame 30 has a vertical wall 30a and a cutout 30n. The vertical wall 30a defines the periphery of the frame 30.

The vertical wall 30a includes a linear portion 30p, a first bend 30q, a second bend 30r, a third bend 30s, and a fourth bend 30t.

The linear portion 30p is located in a portion of the vertical wall 30a in K-direction. The linear portion 30p extends in the front-rear direction.

The first bend 30q is located rearward in the vertical wall 30a. The first bend 30q is connected to the rear end of the linear portion 30p. The first bend 30q is bent to protrude rearward.

The second bend 30r is located frontward in the vertical wall 30a. The second bend 30r is connected to the front end of the linear portion 30p. The second bend 30r is bent to protrude frontward.

The third bend 30s is located to connect the first bend 30q and the cutout 30n. The third bend 30s is connected to an end of the first bend 30q in L-direction. The third bend 30s is bent to protrude in L-direction.

The fourth bend 30t is located to connect the second bend 30r and the cutout 30n. The fourth bend 30t is connected to an end of the second bend 30r in L-direction. The fourth bend 30t is bent to protrude in L-direction.

As shown in FIG. 6, the cover 32 has a vertical wall 32a and a cutout 32n. The vertical wall 32a of the cover 32 is located in correspondence with the vertical wall 30a of the frame 30. The cutout 32n in the cover 32 is located in correspondence with the cutout 30n in the frame 30.

When the cover 32 is closed, the vertical wall 30a of the frame 30 is aligned with the vertical wall 32a of the cover 32. Also, the cutout 30n in the frame 30 is aligned with the cutout 32n in the cover 32. The cutout 30n in the frame 30 and the cutout 32n in the cover 32 define the recess 10n in the body 10.

The vertical wall 32a includes a linear portion 32p, a first bend 32q, a second bend 32r, a third bend 32s, and a fourth bend 32t.

When the cover 32 is closed, the linear portion 32p of the cover 32 is aligned with the linear portion 30p of the frame 30. Also, the first bend 32q of the cover 32 is aligned with the first bend 30q of the frame 30. Also, the second bend 32r of the cover 32 is aligned with the second bend 30r of the frame 30. Also, the third bend 32s of the cover 32 is aligned with the third bend 30s of the frame 30. Also, the fourth bend 32t of the cover 32 is aligned with the fourth bend 30t of the frame 30.

As shown in FIG. 6, the frame 30 includes locking members 30d. The cover 32 includes locking members 32d that are fastened to the locking members 30d. The locking members 30d and the locking members 32d are fastened to allow the cover 32 to remain closed.

As shown in FIG. 5, the frame 30 supports a first saw wheel 40 and a second saw wheel 42. The first and second saw wheels 40 and 42 are located in the internal space of the body 10. The first and second saw wheels 40 and 42 support the band saw blade 12. The second saw wheel 42 is located frontward from the first saw wheel 40.

The band saw blade 12 is an endless saw blade. The band saw blade 12 is formed from a metal. The band saw blade 12 is placed on the first and second saw wheels 40 and 42 while being pulled by the tension adjuster 18 in the front-rear direction.

The first saw wheel 40 rotates about a rotation axis BX. The second saw wheel 42 rotates about a rotation axis CX. The rotation axes BX and CX are parallel to the rotation axis MX of the motor 20. The rotation axis BX of the first saw wheel 40 aligns with the rotation axis MX of the motor 20.

The motor 20 generates power for rotating the first saw wheel 40. When the motor 20 is driven, the first saw wheel 40 rotates. When the first saw wheel 40 rotates with the band saw blade 12 on the first and second saw wheels 40 and 42, the band saw blade 12 rotates. This rotates the second saw wheel 42. The second saw wheel 42 rotates to follow the first saw wheel 40. In this manner, when the motor 20 is driven and thus the first saw wheel 40 rotates, the band saw blade 12 rotates while being supported by the first and second saw wheels 40 and 42.

The frame 30 includes a guide 44 for guiding the band saw blade 12. The guide 44 includes a first guide 44a and a second guide 44b. The first guide 44a is located frontward from the cutout 30n. The second guide 44b is located rearward from the cutout 30n. The first and second guides 44a and 44b each include a pair of rollers with the band saw blade 12 between them. The guide 44 guides the band saw blade 12 to twist the band saw blade 12 in the recess 10n. The guide 44 in the embodiment guides the band saw blade 12 to have the surface of the cutting portion 12c of the band saw blade 12 parallel to the vertical direction.

The band saw blade 12 in the embodiment rotates to move the cutting portion 12c rearward in the recess 10n.

As shown in FIG. 6, the cover 32 has an opening 32b and an opening 32c. The opening 32b receives at least a part of the first saw wheel 40. The opening 32c receives at least a part of the second saw wheel 42. The first saw wheel 40 is at least partially exposed through the opening 32b. The second saw wheel 42 is at least partially exposed through the opening 32c.

As shown FIGS. 2 and 3, the stopper plate assembly 14 is attached to the frame 30. The stopper plate assembly 14 supports a workpiece. The stopper plate assembly 14 prevents a workpiece from moving as the band saw blade 12 rotates. The stopper plate assembly 14 is located downstream in the direction of movement of the band saw blade 12 in the recess 10n. The stopper plate assembly 14 in the embodiment is located at the rear end of the recess 10n.

The stopper plate assembly 14 includes a plate 14a and bolts 14b. The plate 14a has a long hole 14a1 to receive the bolts 14b. The positions of the long hole 14a1 and the bolts 14b are adjusted to position the plate 14a. The bolts 14b are fastened to the frame 30 of the body 10.

The hook 16 can be hooked on an object. The hook 16 is located at the front end of the surface 30f of the frame 30. The hook 16 is rotatably supported by the frame 30.

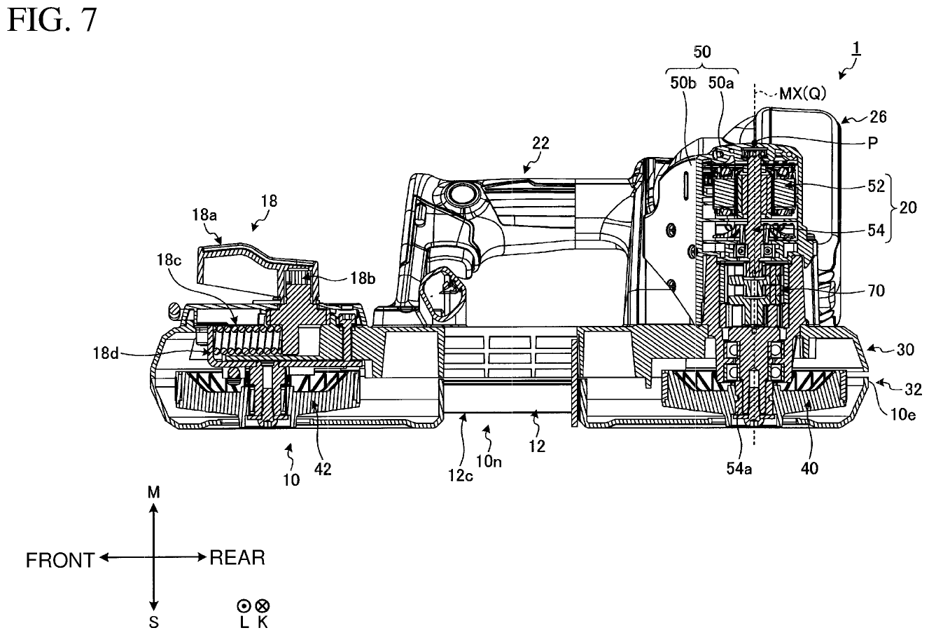

FIG. 7 is a cross-sectional view of the portable band saw 1 according to the embodiment from L-direction. As shown in FIG. 7, the tension adjuster 18 is mounted on the body 10. The tension adjuster 18 adjusts the tension of the band saw blade 12. The tension adjuster 18 is located frontward from the recess 10n. The tension adjuster 18 includes a lever 18a, a cam 18b, a spring 18c, and a moving member 18d. The cam 18b rotates as the lever 18a rotates. This compresses the spring 18c. The spring 18c generates an elastic force for moving the moving member 18d forward. The moving member 18d is connected to the second saw wheel 42. The second saw wheel 42 receives an elastic force from the spring 18c for moving the second saw wheel 42 backward.

The motor 20 is an electric motor drivable with electric power from the battery 26. As shown in FIG. 7, the motor 20 is mounted on the frame 30 of the body 10 with a decelerator 70 between them. The motor 20 is located rearward from the recess 10n.

The motor 20 includes a stator 52 and a rotor 54. The motor 20 is accommodated in a housing 50. The motor 20 is located rearward from the recess 10n and frontward from a rear end 10e of the body 10. The motor 20 protrudes from the frame 30 in M-direction.

The housing 50 includes a first portion 50a and a second portion 50b. The first portion 50a serves as a motor housing for accommodating the motor 20. The second portion 50b accommodates wires and other interconnections connected to the stator 52. As shown in FIG. 2, the first portion 50a protrudes from the frame 30 in M-direction. The second portion 50b protrudes frontward from the first portion 50a. The second portion 50b is inclined frontward in K-direction.

The stator 52 is cylindrical. The rotor 54 is located inside the stator 52. As shown in FIG. 7, the rotor 54 has a joint 54a at its distal end in S-direction connected to the first saw wheel 40. The first saw wheel 40 rotates as the rotor 54 rotates.

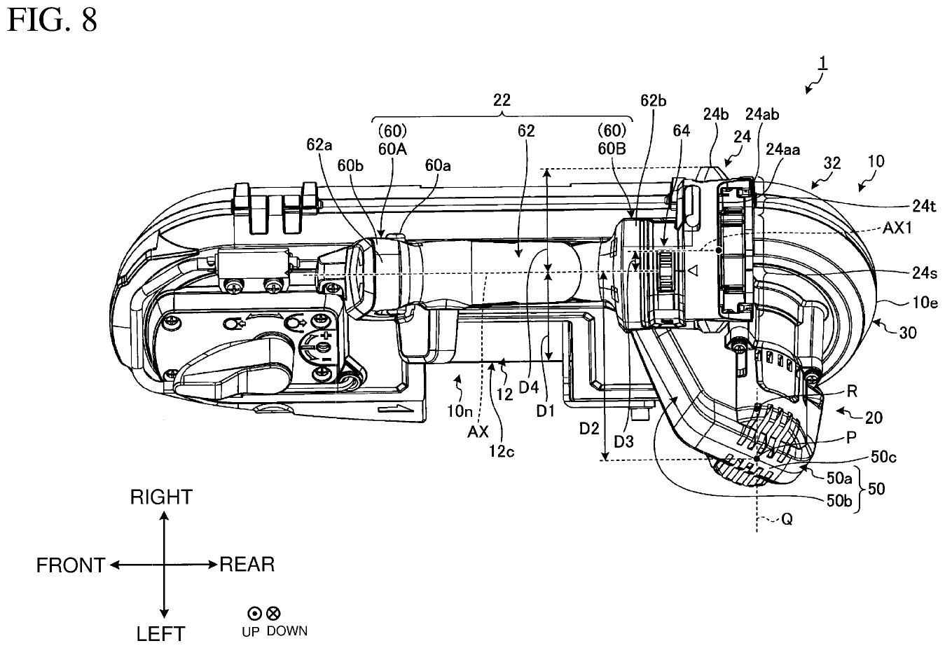

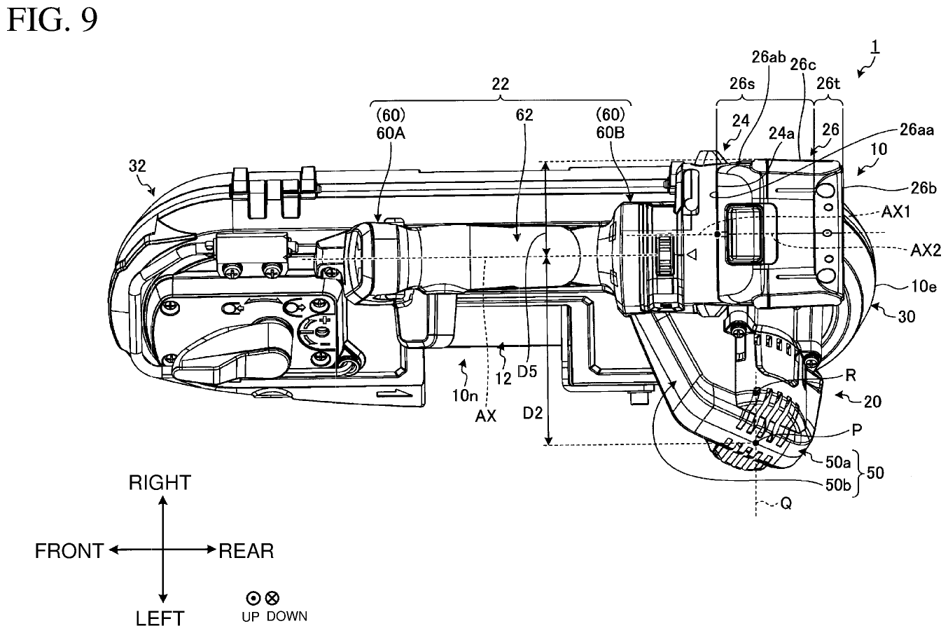

FIGS. 8 and 9 are views of the portable band saw 1 according to the embodiment from above. FIG. 8 shows the portable band saw 1 without the battery 26 attached to the battery mount 24. FIG. 9 shows the portable band saw 1 with the battery 26 attached to the battery mount 24. As shown in FIGS. 8 and 9, the handle 22 is supported by the frame 30 of the body 10. The handle 22 includes the supports 60 and the grip 62.

The supports 60 include a support 60A and a support 60B. The support 60A is located frontward from the recess 10n. The support 60B is located rearward from the recess 10n.

The supports 60 extend in the vertical direction. The supports 60 include lower ends 60a and upper ends 60b. The lower ends 60a of the supports 60 are connected to the surface of the frame 30.

The grip 62 is grippable by an operator. The grip 62 extends in the front-rear direction. The grip 62 has a front end 62a and a rear end 62b. The grip 62 has the front end 62a connected to the upper end 60b of the support 60A, and the rear end 62b connected to the upper end 60b of the support 60B.

The grip 62 has an operation part 64 at the rear end 62b for adjusting the rotational speed of the band saw blade 12. The operator operates the operation part 64 to change the rotational speed of the band saw blade 12.

Positional Relationship between Handle, Motor, and Battery

The grip 62 is located rightward from the motor 20. The grip 62 is located upward and rightward from the cutting portion 12c of the band saw blade 12. The left end of the grip 62 aligns with the right end of the recess 10n in the lateral direction.

The grip 62 has a larger dimension than the recess 10n in the front-rear direction. The grip 62 has the front end 62a frontward from the front end of the recess 10n, and the rear end 62b rearward from the rear end of the recess 10n. The grip 62 of the handle 22 at least partially aligns with the cutting portion 12c of the band saw blade 12 in the front-rear direction.

The grip 62 has a central axis AX extending in the front-rear direction. The central axis AX passes through the center of the grip 62 in the lateral direction. The first portion 50a has an end face 50c in M-direction. A center point P refers to a crossing point between the rotation axis MX of the motor 20 and the end face 50c. The center point P may be the center of the motor 20 in the front-rear direction. A distance D1 refers to a distance in the lateral direction between the central axis AX of the grip 62 and the cutting portion 12c of the band saw blade 12. A distance D2 refers to a distance in the lateral direction between the central axis AX of the grip 62 and the center point P. In this case, the distance D2 is larger than the distance D1. More specifically, the motor 20 at least partially protrudes leftward from the cutting portion 12c.

A virtual plane Q refers to a plane including the center point P and extending in the vertical and lateral directions. The virtual plane Q may be the center of the motor 20 in the front-rear direction. A center R of the motor 20 in the lateral direction is defined on the virtual plane Q. In some embodiments, a center R of the motor 20 in the lateral direction may not be defined on the virtual plane Q.

The battery mount 24 includes a connector terminal connectable to a power terminal of the battery 26. The battery 26 is attached to the battery mount 24 to power the portable band saw 1.

As shown in FIG. 8, the battery mount 24 is located at the rear of the handle 22. The battery mount 24 in the embodiment is located at the rear end 62b of the grip 62. The handle 22 is integral with the battery mount 24.

The battery mount 24 at least partially protrudes rightward from the rear end 62b of the grip 62. The battery mount 24 includes a portion 24s, a portion 24t, and a protrusion 24b. The portion 24s is located rearward from the grip 62. The portion 24t protrudes rightward from the portion 24s. The protrusion 24b protrudes rightward from the portion 24t. The grip 62 aligns with the portion 24s in the lateral direction. The portion 24t is located rightward from the grip 62 in the lateral direction. The battery mount 24 is at least partially located rightward from the grip 62.

The battery mount 24 has a central axis AX1 extending in the front-rear direction. The central axis AX1 passes through the center of the battery mount 24 in the lateral direction. In the lateral direction, the central axis AX1 of the battery mount 24 is located rightward from the central axis AX of the grip 62. More specifically, the center of the battery mount 24 is located rightward from the center of the handle 22 in the lateral direction.

A distance D3 refers to a distance in the lateral direction between the central axis AX and the central axis AX1. In this case, the distance D3 is smaller than the distances D1 and D2. A distance D4 refers to a distance in the lateral direction between the right end face of the protrusion 24b of the battery mount 24 and the central axis AX of the grip 62. In this case, the distance D4 is smaller than the distance D2. More specifically, the battery mount 24 protrudes less from the grip 62 than the motor 20 from the grip 62 in the lateral direction.

The battery mount 24 has an upper rear end face 24aa and a lower rear end face 24ab located frontward from the rear end 10e of the body 10 (frame 30). The upper rear end face 24aa is located rearward from the lower rear end face 24ab. The upper and lower rear end faces 24aa and 24ab are planes. The upper and lower rear end faces 24aa and 24ab are parallel to each other. The battery mount 24 is at least partially located rightward from the recess 10n in the body 10. The battery mount 24 is located frontward from the rear end 10e.

The upper rear end face 24aa of the battery mount 24 is located frontward from the center point P. As described above, the center point P is a crossing point between the rotation axis MX of the motor 20 and the end face 50c. The battery mount 24 is located frontward from the center (virtual plane Q) of the motor 20.

The center point P of the motor 20 is located leftward from the central axis AX of the grip 62 of the handle 22. The center R of the motor 20 is located leftward from the center of the grip 62 of the handle 22 in the lateral direction.

As shown in FIG. 9, the battery 26 is attached to the battery mount 24. The battery 26 has an upper front end face 26aa, a lower front end face 26ab, and a rear end face 26b. The upper and lower front end faces 26aa and 26ab face the battery mount 24. The rear end face 26b faces in the opposite direction from the upper front end face 26aa. The upper front end face 26aa is located frontward from the lower front end face 26ab. The upper and lower front end faces 26aa and 26ab are planes. The upper and lower front end faces 26aa and 26ab are parallel to each other.

The upper front end face 26aa has the same shape as the upper rear end face 24aa of the battery mount 24. The lower front end face 26ab has the same shape as the lower rear end face 24ab of the battery mount 24. When the battery 26 is attached to the battery mount 24, the rear end face 26b is located frontward from the rear end 10e of the body 10. More specifically, the battery 26 is located frontward from the rear end 10e of the body 10. The battery 26 is at least partially located rightward from the recess 10n in the body 10.

The battery 26 and the motor 20 are arranged in the lateral direction. The battery 26 at least partially aligns with the motor 20 in the front-rear direction. The battery 26 in the embodiment includes a portion 26s and a portion 26t. The portion 26t is located rearward from the portion 26s. The portion 26s aligns with the motor 20 in the front-rear direction. The portion 26t is located rearward from the motor 20.

The battery 26 has a central axis AX2 extending in the front-rear direction. The central axis AX2 passes through the center of the battery 26 in the lateral direction. The central axis AX2 of the battery 26 is located rightward from the central axis AX of the grip 62 in the lateral direction. More specifically, the center of the battery 26 is located rightward from the center of the handle 22 in the lateral direction.

The center of the battery mount 24 aligns with the center of the battery 26 in the lateral direction. The central axis AX1 of the battery mount 24 aligns with the central axis AX2 of the battery 26. The center of the battery 26 is located rightward from the center of the grip 62 of the handle 22 in the lateral direction.

As shown in FIG. 9, a distance D5 refers to a distance in the lateral direction between a right end face 26c of the battery 26 and the central axis AX of the grip 62. In this case, the distance D5 is smaller than the distance D2. More specifically, the battery 26 protrudes less from the grip 62 than the motor 20 from the grip 62 in the lateral direction.

The operator uses the portable band saw 1 to perform an operation while gripping the handle 22. The portable band saw 1 may have a substantially equally balanced weight in the lateral direction to improve operability. In the embodiment, the motor 20 is located leftward from the handle 22, and the battery 26 is located rightward from the handle 22. This structure allows the portable band saw 1 to have a substantially equally balanced weight in the lateral direction with the handle 22 serving as a supporting point. The portable band saw 1 may have smaller overall dimensions to improve operability. In the embodiment, the handle 22 at least partially aligns with the cutting portion 12c of the band saw blade 12 in the front-rear direction. The battery 26 at least partially aligns with the motor 20 in the front-rear direction. This structure allows the portable band saw 1 to have a smaller dimension in the front-rear direction and have a substantially equally balanced weight in the lateral direction.

In the present embodiment described above, the center R of the motor 20 is located on one side (the left) of the center (central axis AX) of the handle 22, and the center (central axis AX2) of the battery 26 is located on the other side (the right) of the center of the handle 22. With respect to the central axis AX of the handle 22, the motor 20 has the center of gravity located leftward, and the battery 26 has the center of gravity located rightward. This structure allows the portable band saw 1 to have a substantially equally balanced weight in the lateral direction.

The handle 22 at least partially aligns with the cutting portion 12c of the band saw blade 12 in the front-rear direction. The battery 26 at least partially aligns with the motor 20 in the front-rear direction. This structure allows the portable band saw 1 to have a smaller dimension in the front-rear direction. This structure also allows the portable band saw 1 to have a substantially equally balanced weight in the lateral direction.

The battery mount 24 is located rearward from the handle 22. The battery mount 24 in the embodiment is located at the rear of the handle 22 and is integral with the handle 22. This allows the portable band saw 1 to have a simpler structure and smaller overall dimensions.

The battery mount 24 is located frontward from the center (virtual plane Q) of the motor 20. The battery 26 is thus located more frontward, allowing the portable band saw 1 to have smaller overall dimensions.

The battery 26 is located frontward from the rear end 10e of the body 10. The portable band saw 1 includes the battery 26 without protruding rearward from the rear end 10e of the body 10 and thus has smaller overall dimensions.

### OTHER EMBODIMENTS

In the above embodiment, the battery 26 may be at least partially located rearward from the rear end 10e of the body 10.

The battery mount 24 may be located rearward from the center of the motor 20.

The battery mount 24 may be located frontward from the handle 22. The battery mount 24 may be located at least on either the left side or the right side of the handle 22.

The motor 20 may be located frontward from the battery mount 24.

The handle 22 may not align with the cutting portion 12c in the front-rear direction. The battery 26 may not align with the motor 20 in the front-rear direction.

### REFERENCE SIGNS LIST

1 portable band saw
10 body
10e rear end
10n recess
12 band saw blade
12c cutting portion
14 stopper plate assembly
14a plate
14a1 long hole
14b bolt
16 hook
18 tension adjuster
18a lever
18b cam
18c spring
18d moving member
20 motor
22 handle
24 battery mount
24aa upper rear end face
24ab lower rear end face
24b protrusion
24s portion
24t portion
26 battery
26aa upper front end face
26ab lower front end face
26b rear end face
26c right end face
26s portion
26t portion
30 frame
30d locking member
30a vertical wall
30f surface
30n cutout
30p linear portion
30q first bend
30r second bend
30s third bend
30t fourth bend
32 cover
32a vertical wall
32b opening
32c opening
32d locking member
32n cutout
32p linear portion
32q first bend
32r second bend
32s third bend
32t fourth bend
40 first saw wheel
42 second saw wheel
44 guide
44a first guide
44b second guide
50 housing
50a first portion
50b second portion
50c end face
52 stator
54 rotor
54a joint
60 support
60A support
60B support
60a lower end
60b upper end
62 grip
62a front end
62b rear end
64 operation part
70 decelerator
AX central axis
AX1 central axis
AX2 central axis
BX rotation axis
CX rotation axis
MX rotation axis
P center point
Q virtual plane
R center

What is claimed is:

1. A portable band saw, comprising:
a battery mount to which a battery is attachable;
a motor driven with electric power from the battery;
a band saw blade being endless and rotatable with power generated by the motor;
a body supporting the motor and the band saw blade; and
a handle including
a support connected to the body and extending in a vertical direction, and
a grip connected to the support and extending in a front-rear direction,
wherein in a lateral direction, the motor has a center on one side of a center of the handle, and the battery has a center on another side of the center of the handle.

2. The portable band saw according to claim 1, wherein
the handle at least partially aligns with a cutting portion of the band saw blade in the front-rear direction, and
the battery at least partially aligns with the motor in the front-rear direction.

3. The portable band saw according to claim 1, wherein
the battery mount is located rearward from the handle.

4. The portable band saw according to claim 1, wherein
the battery mount is located frontward from the center of the motor.

5. The portable band saw according to claim 1, wherein
the battery is located frontward from a rear end of the body.

6. The portable band saw according to claim 1, wherein
a distance in the lateral direction between a central axis of the grip and a central axis of the battery mount is smaller than a distance in the lateral direction between the central axis of the grip and a center point of the motor in the front-rear direction.

7. The portable band saw according to claim 1, wherein
a distance in the lateral direction between a central axis of the grip and a central axis of the battery mount is smaller than a distance in the lateral direction between the central axis of the grip and a cutting portion of the band saw blade.

8. The portable band saw according to claim 1, wherein
a distance in the lateral direction between a central axis of the grip and a center point of the motor in the front-rear direction is larger than a distance in the lateral direction between the central axis of the grip and a cutting portion of the band saw blade.

9. The portable band saw according to claim 1, wherein
a distance in the lateral direction between an outer end face of the battery and a central axis of the grip is smaller than a distance in the lateral direction between the central axis of the grip and a center point of the motor in the front-rear direction.

10. The portable band saw according to claim 1, wherein
the battery has a rear end face located rearward from a center point of the motor in the front-rear direction.

11. The portable band saw according to claim 2, wherein
the battery mount is located rearward from the handle.

12. The portable band saw according to claim 2, wherein
the battery mount is located frontward from the center of the motor.

13. The portable band saw according to claim 3, wherein
the battery mount is located frontward from the center of the motor.

14. The portable band saw according to claim 2, wherein
the battery is located frontward from a rear end of the body.

15. The portable band saw according to claim 3, wherein
the battery is located frontward from a rear end of the body.

16. The portable band saw according to claim 4, wherein
the battery is located frontward from a rear end of the body.

17. The portable band saw according to claim 2, wherein
a distance in the lateral direction between a central axis of the grip and a central axis of the battery mount is smaller than a distance in the lateral direction between the central axis of the grip and a center point of the motor in the front-rear direction.

18. The portable band saw according to claim 3, wherein
a distance in the lateral direction between a central axis of the grip and a central axis of the battery mount is smaller than a distance in the lateral direction between the central axis of the grip and a center point of the motor in the front-rear direction.

19. The portable band saw according to claim 4, wherein
a distance in the lateral direction between a central axis of the grip and a central axis of the battery mount is smaller than a distance in the lateral direction between the central axis of the grip and a center point of the motor in the front-rear direction.

20. The portable band saw according to claim 5, wherein
a distance in the lateral direction between a central axis of the grip and a central axis of the battery mount is smaller than a distance in the lateral direction between the central axis of the grip and a center point of the motor in the front-rear direction.
